(19) United States
(12) Patent Application Publication
(10) Pub. No.: US 2026/0089562 A1
(43) Pub. Date: Mar. 26, 2026

(54) WIRELESS COMMUNICATION TRAFFIC MANAGEMENT WITH IMPROVED COEXISTENCE

(71) Applicant: SAMSUNG ELECTRONICS CO., LTD., Suwon-si (KR)

(72) Inventor: Jesús Manuel Pérez Pueyo, Cambridge (GB)

(73) Assignee: SAMSUNG ELECTRONICS CO., LTD., Suwon-si (KR)

(21) Appl. No.: 18/896,085

(22) Filed: Sep. 25, 2024

(51) Int. Cl. H04W 28/06; H04L 69/22; H04W 28/02; H04W 76/10; H04W 84/18

(52) U.S. Cl. CPC H04W 28/065; H04L 69/22; H04W 28/021; H04W 76/10; H04L 2212/00; H04W 84/18

(57) ABSTRACT

Methods and devices for performing wireless communication, including: establishing a first wireless connection between the first electronic device and a second electronic device; transmitting, to the second electronic device, a first packet comprising a header and a payload, wherein the header indicates that the payload has a reported payload length, and wherein the payload has an actual payload length that is shorter than the reported payload length; and during a time period corresponding to the reported payload length, communicating with a third electronic device different from the second electronic device.

### BACKGROUND

### 1. Field

The disclosure relates to managing wireless communication, and more particularly to managing message traffic to avoid interference and improve coexistence in wireless networks.

### 2. Description of Related Art

Bluetooth communication technology may provide a short-range wireless communication technique that enables electronic devices to be connected to each other for exchanging data or information. Bluetooth communication technology may include Bluetooth legacy (or Bluetooth classic) communication technology and Bluetooth low-energy (BLE) communication technology, and may have topology in the form of various connections such as a piconet and/or a scatternet.

During Bluetooth operation in the presence of other wireless activities, for example other Bluetooth operations or other types of wireless communication operations, the Bluetooth traffic may sometimes clash or interfere with the other wireless activities, which may force the participating electronic devices to choose one and exclude the others.

### SUMMARY

Provided are methods and devices for managing message traffic in wireless communication in order to avoid interference and improve coexistence in wireless networks such as Bluetooth networks.

Additional aspects will be set forth in part in the description which follows and, in part, will be apparent from the description, or may be learned by practice of the presented embodiments.

In accordance with an aspect of the disclosure, a method of performing wireless communication is executed by at least one processor of a first electronic device, and includes: establishing a first wireless connection between the first electronic device and a second electronic device; transmitting, to the second electronic device, a first packet comprising a header and a payload, wherein the header indicates that the payload has a reported payload length, and wherein the payload has an actual payload length that is shorter than the reported payload length; and during a time period corresponding to the reported payload length, communicating with a third electronic device different from the second electronic device.

In accordance with an aspect of the disclosure, a first electronic device for performing wireless communication includes: a communication interface configured to perform wireless communication with a second electronic device and a third electronic device; at least one processor; and a memory configured to store instructions which, when executed by the at least one processor, causes the first electronic device to: establish a first wireless connection between the first electronic device and a second electronic device using the communication interface; transmit, to the second electronic device, a first packet comprising a header and a payload, wherein the header indicates that the payload has a reported payload length, and wherein the payload has an actual payload length that is shorter than the reported payload length; and during a time period corresponding to the reported payload length, communicate with a third electronic device different from the second electronic device.

In accordance with an aspect of the disclosure, a non-transitory computer-readable medium includes instructions which, when executed by at least one processor of a first electronic device for performing wireless communication, causes the first electronic device to: establish a first wireless connection between the first electronic device and a second electronic device; transmit, to the second electronic device, a first packet comprising a header and a payload, wherein the header indicates that the payload has a reported payload length, and wherein the payload has an actual payload length that is shorter than the reported payload length; and during a time period corresponding to the reported payload length, communicate with a third electronic device different from the second electronic device.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to embodiments;

FIG. 2 is a block diagram illustrating an electronic device according to embodiments;

FIGS. 3A to 3C are diagrams illustrating examples of network topologies which may be used for wireless communication, according to embodiments;

FIG. 4 is a diagram illustrating example packet formats, according to embodiments;

FIG. 5 is a flowchart illustrating an example process for performing wireless communication, according to embodiments; and

FIG. 6 is a flowchart illustrating an example process for performing wireless communication, according to embodiments.

### DETAILED DESCRIPTION

Advantages and features of embodiments of the disclosure, and methods of achieving them, will be more apparent with reference to the description below in conjunction with the accompanying drawings. However, embodiments are not limited thereto. In addition, specific configurations described only in a particular embodiment may be used in other embodiments. Throughout the description below, the same reference numerals may generally refer to the same elements.

The terminology used herein is for the purpose of describing example embodiments and is not intended to limit the scope of the disclosure. In this specification, the singular also includes the plural, unless specifically stated otherwise in the phrase. As used herein, “comprises” and/or “comprising” may mean that a recited element, step, operation, and/or apparatus does not exclude the presence or addition of one or more other elements, steps, operations, and/or apparatuses.

Unless otherwise defined, all terms (including technical and scientific terms) used herein may be used with the meaning commonly understood by those of ordinary skill in the art to which this disclosure belongs. In addition, terms defined in a commonly used dictionary are not to be interpreted ideally or excessively unless clearly defined in particular.

In addition, before proceeding with the detailed description that follows, definitions of certain words and phrases used herein are set forth. The terms “comprise” and “include” and derivatives of the terms “comprise” and “include” denote inclusive without limitation. The word “connects” and derivatives of the word “connect” refer to any direct or indirect communication between two or more components, whether or not the two or more components are in physical contact with each other. The terms “transmit”, “receive”, and “communicate”, and derivatives of the terms “transmit”, “receive”, and “communicate” include both direct and indirect communication. The word “or” is an inclusive word meaning ‘and/or’. The word “related to” and derivatives of “related to” denote to include, to be included in, to interconnect with, to imply, to be implied in, to connect with, to combine with, to communicate with, to cooperate with, to intervene, to place alongside, to approximate, to be bound by, to have, to have the characteristics of, to relate to, and the like. The term “controller” denotes any apparatus, system, or part thereof that controls at least one operation. Such a controller may be implemented in hardware or a combination of hardware and software and/or firmware. Functions associated with any particular controller may be centralized or distributed, either locally or remotely. The phrase “at least one”, when used with a list of items, denotes that different combinations of one or more of the listed items may be used, and that only one item in the list may be required. For example, “at least one of A, B, and C” includes any one of combinations of A, B, C, A and B, A and C, B and C, and A, B and C.

In addition, various functions described below may be implemented or supported by artificial intelligence technology or one or more computer programs, and each of the programs may include computer-readable program code and may be embodied in a computer-readable medium. The terms “application” and “program” refer to one or more computer programs, software components, sets of instructions, procedures, functions, objects, classes, instances, related data, or portions thereof suitable for implementation of suitable computer-readable program code. The term “computer-readable program code” includes computer code of any type, including source code, object code, and executable code. The term “computer-readable medium” includes any type of medium that may be accessed by a computer, such as read only memory (ROM), random access memory (RAM), a hard disk drive, a compact disk (CD), a digital video disk (DVD), or any other type of memory. A “non-transitory” computer-readable medium excludes wired, wireless, optical, or other communication links that transmit transitory electrical or other signals. Non-transitory computer-readable media includes media in which data may be permanently stored, and media in which data is stored and may be overwritten later, such as a rewritable optical disc or a removable memory apparatus.

In various example embodiments described below, a hardware approach is described as an example. However, because various example embodiments include technology using both hardware and software, the various example embodiments do not exclude a software-based approach.

In addition, terms referring to control information, terms referring to entries, terms referring to network entities, terms referring to messages, and terms referring to a component of an apparatus, used in the description to be described below, are examples for convenience of description. Accordingly, the example embodiments are not limited to the terms described below, and other terms having equivalent technical meanings may be used.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Hereinafter, electronic devices are described according to embodiments of the present disclosure, but one or more of the electronic devices may be referred to as terminal, a mobile station, a mobile equipment (ME), and a user equipment (UE), a user terminal (UT), a subscriber station (SS), a wireless device, a handheld device, or an access terminal (AT). In some embodiments, one or more of the electronic devices may be, for example, a mobile phone, a personal digital assistant (PDA), a smart phone, a wireless modem, a device having a communication function, such as a notebook computer.

In the description below, reference is made to Bluetooth wireless communication technology, but embodiments may be applied other communication systems having a similar technical background.

During Bluetooth operation in the presence of other wireless activities, for example other Bluetooth operations or other types of wireless communication operations, the Bluetooth traffic may sometimes clash or interfere with the other wireless activities, which may force the participating electronic devices to choose one and exclude the others.

Embodiments of the present disclosure may allow an electronic device to produce gaps in communication on a Bluetooth connection, so that other activities, which may otherwise clash or interfere in time with that communication, may be performed in those gaps. This may allow other activities to happen, which would otherwise be blocked by the ongoing Bluetooth activity. In addition, the embodiments may allow the Bluetooth communication being performed on the Bluetooth connection to avoid bursts of interference if those are known, making the communication on the Bluetooth link more robust. Further, embodiments may allow peer devices engaged in the Bluetooth communication to transmit at specific instants in time, which may prevent communication losses while allowing other activities to be serviced.

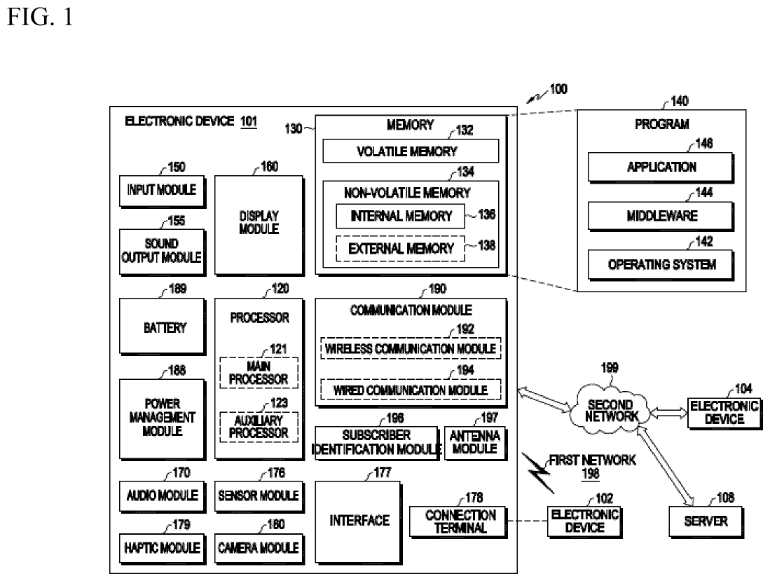

FIG. 1 is a block diagram illustrating an example of an electronic device in a network environment, according to embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). In some embodiments, the first network 198 may be a Bluetooth network, but embodiments are not limited thereto. According to embodiments, the electronic device 101 may communicate with the electronic device 104 via the server 108. The electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. The processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to embodiments, the auxiliary processor 123 (e.g., an image signal processor or a communication processor) may be implemented as part of another component (e.g., the camera module 180 or the communication module 190) functionally related to the auxiliary processor 123. According to embodiments, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to embodiments, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to embodiments, the display module 160 may include a touch sensor adapted to detect a touch, or a pressure sensor adapted to measure the intensity of force incurred by the touch.

The audio module 170 may convert a sound into an electrical signal and vice versa. According to embodiments, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to embodiments, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to embodiments, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to embodiments, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to embodiments, the haptic module 179 may include, for example, a motor, a piezoelectric element, or an electric stimulator.

The camera module 180 may capture a still image or moving images. According to embodiments, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to embodiments, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to embodiments, the antenna module 197 may include an antenna including a radiating element composed of a conductive material or a conductive pattern formed in or on a substrate (e.g., a printed circuit board (PCB)). According to embodiments, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to embodiments, another component (e.g., a radio frequency integrated circuit (RFIC)) other than the radiating element may be additionally formed as part of the antenna module 197.

According to one embodiment, the antenna module 197 may form a mmWave antenna module. According to embodiments, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to embodiments, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to embodiments, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to embodiments, the external electronic device 104 or the server 108 may be included in the second network 199. The electronic device 101 may be applied to intelligent services (e.g., smart home, smart city, smart car, or healthcare) based on 5G communication technology or IoT-related technology.

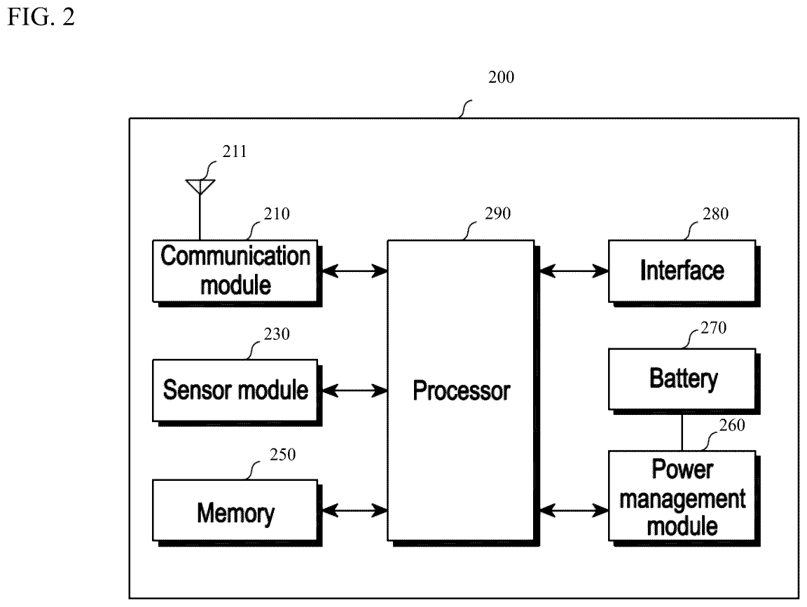

FIG. 2 is a block diagram illustrating another example configuration of an electronic device, according to embodiments.

Referring to FIG. 2, the electronic device 200 may include an antenna module 211, a communication module 210, a sensor module 230, a memory 250, a power management module 260, a battery 270, an interface 280, and a processor 290.

According to embodiments, the communication module 210 may include at least one of a wireless communication module (e.g., a Bluetooth communication module, a cellular communication module, a Wi-Fi communication module, a near-field communication (NFC) communication module, and a GNSS communication module) and a wired communication module (e.g., a LAN communication module and a PLC communication module).

The communication module 210 may directly or indirectly communicate with one or more other electronic devices using one or more communication modules included therein. The communication module 210 may operate independently of the processor 290 and include one or more communication processors supporting wired or wireless communication. In an embodiment, the communication module 210 may also be referred to as a communication interface.

According to embodiments, the antenna module 211 may transmit or receive signals or information to or from another electronic device.

According to embodiments, the antenna module 211 may include a plurality of antennas, and at least one antenna suitable for a communication scheme used in the communication network may be selected from the plurality of antennas by the communication module 210. Signals or information may be transmitted or received between the communication module 210 and another electronic device through the at least one selected antenna.

According to embodiments, the memory 250 may store a variety of data used by at least one element (e.g., the processor 290, the communication module 210, or the sensor module 230) of the electronic device 200. The data may include, for example, software and input data or output data for instructions related thereto. The memory 250 may include a volatile memory or a nonvolatile memory.

According to embodiments, the power management module 260 may manage power supplied to the electronic device 200. According to embodiments, the power management module 260 may be implemented as, for example, at least a part of the PMIC. According to embodiments, the power management module 260 may include a battery charging module.

According to embodiments, when the power management module 260 is electrically connected to an external power supply device through wireless or wired connection, the power management module 260 may receive power supplied from the external power supply device to charge the battery 270.

According to embodiments, the battery 270 may supply power to at least one element of the electronic device 200. According to embodiments, battery 270 may include, for example, a rechargeable battery.

According to embodiments, the interface 280 may support one or more specified protocols to be used in order for the electronic device 200 to directly connect (e.g., wired connection) with another electronic device. According to embodiments, the interface 280 may include, for example, an HDMI, a USB interface, an SD card interface, or an audio interface.

According to embodiments, the processor 290 may execute software to control at least one other element (e.g., hardware or software elements) of the electronic device 200 connected to the processor 290 and perform processing of a variety of data or operations.

According to embodiments, as at least part of data processing or operations, the processor 290 may load commands or data received from another element (e.g., the sensor module 230 or the communication module 210) in the volatile memory 250, process commands or data stored in the volatile memory 250, and store the resultant data in the nonvolatile memory.

According to embodiments, the electronic device 200 may further include various modules. For example, other elements equivalent to the above-described elements may be further included in the electronic device 200. In some embodiments, the electronic device 200 according to embodiments may exclude specific elements from the above elements or replace the same with other elements.

According to embodiments, an electronic device such as the electronic device 100 and the electronic device 200 discussed above may perform wireless communication according to a Bluetooth communication protocol, for example at least one of a Bluetooth Classic communication protocol and a Bluetooth Low Energy (BLE) communication protocol. Bluetooth Classic may use two general modes to transmit data, Basic Rate (BR) and Enhanced Data Rate (EDR). According to embodiments, BR transmissions may be performed using Gaussian frequency-shift keying (GFSK) modulation at 1 megabit per second (Mbps), and EDR transmissions may be performed using at least one of π/4 differential quadrature phase shift keying (DQPSK) modulation at 2 Mbps, and differential 8-level phase-shift keying (8DPSK) modulation at 3 Mbps.

According to embodiments, two or more electronic devices may conduct Bluetooth communication by acting as central devices and peripheral devices to form a piconet. In some embodiments, a connection between one or more central devices and one or more peripheral devices may be referred to as a link. A piconet may refer to a one-to-one link or one-to-many link in which a single central device, which may maintain a master clock, may be connected to up to seven peripheral devices. In some embodiments, a central device may be referred to as a master device, and a peripheral device may be referred to as a slave device.

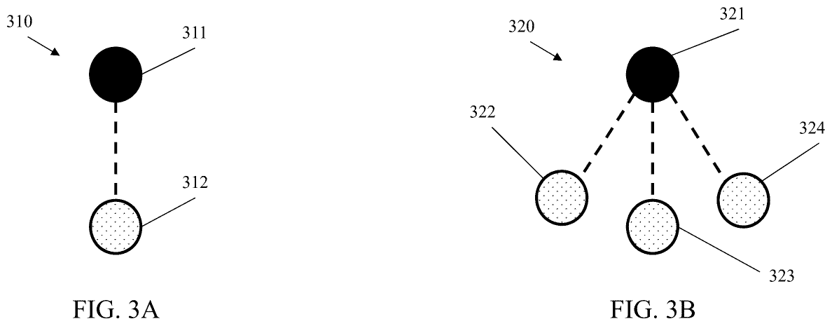

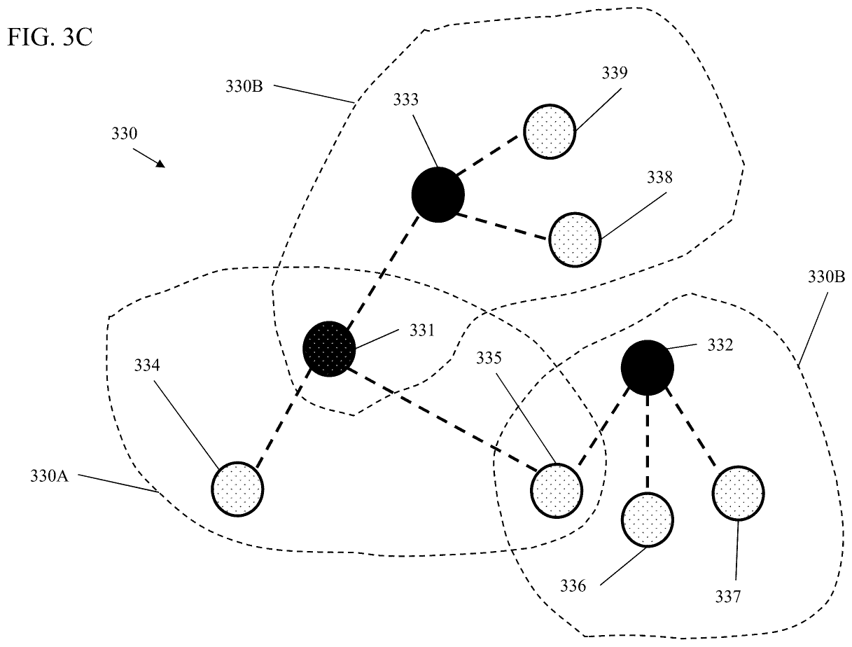

FIGS. 3A to 3C show example network topologies which may be used in wireless communication such as Bluetooth communication. For example, FIG. 3A illustrates a piconet 310 including an electronic device 311 which may operate as a central device, and which may be connected to an electronic device 312, which may operate as a peripheral device. FIG. 3B illustrates a piconet 320 including an electronic device 321 which may operate as a central device, and which may be connected to an electronic device 321, an electronic device 323, and an electronic device 324, which may operate as peripheral devices.

According to embodiments, multiple piconets may share peripheral devices, or central devices that operate as a peripheral device in another piconet. When this occurs, the multiple piconets may form a scatternet. For example, FIG. 3C illustrates a scatternet 330 including a first piconet 330A, a second piconet 330B, and a third piconet 330C. As shown in FIG. 3C, an electronic device 331 may operate as a central device in the first piconet 330A, which may further include an electronic device 334 and an electronic device 335 operating as peripheral devices. In addition, the electronic device 331 may operate as a peripheral device in the second piconet 330B, which may further include an electronic device 333 operating as a central device, and an electronic device 338 and an electronic device 339 operating as peripheral devices. Further, the electronic device 335 may also operate as a peripheral device in the third piconet 330C, which may further include an electronic device 332 operating as a central device, and an electronic device 336 and an electronic device 337 operating as peripheral devices.

According to embodiments, the electronic devices 311 to 339 may correspond to one or more of the electronic device 100 and the electronic device 200 discussed above.

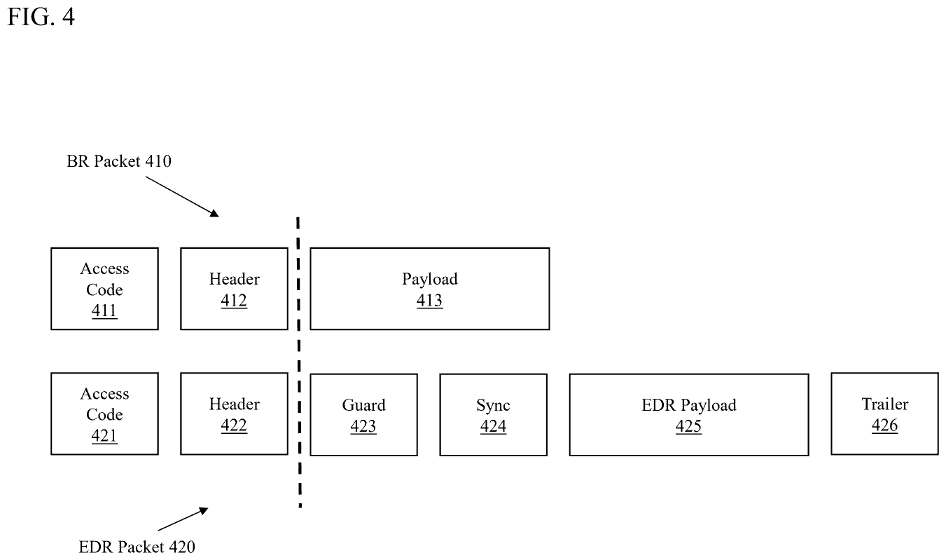

FIG. 4 illustrates example packet formats for packets transmitted according to Bluetooth BDR and EDR modes. As shown in FIG. 4, a BR packet 410 may include an access code 411, a header 412, and a payload 413, all of which may be transmitted using GFSK modulation at 1 Mbps. An EDR packet 420 may include an access code 421 and a header 422, which may also be transmitted using GFSK modulation at 1 Mbps. The header 422 may include a packet type field which may indicate a modulation format that is used to transmit the remainder of the EDR packet 420, and the guard time 423 may provide time to change the modulation. Subsequently, the sync 424, EDR payload 425, and trailer 426 may be sent using the modulation format specified in the header 422. According to embodiments, the header 412 and the header 422 may include a sequence bit SEQN, which may be used to determine whether a packet has been missed. For example, an electronic device may toggle the sequence bit SEQN between values of zero (“0”) and one (“1”) in consecutive transmitted packets.

Bluetooth may support multiple types of data to be sent between a central device and a peripheral device. Each type of data may have different requirements. For example, it may be desirable to send audio data at a consistent rate with relatively low latency and packet losses. However, other types of data may be successfully sent even in the presence of some delays. Accordingly, Bluetooth may use different logical transports, for example synchronous Connection-Oriented (SCO), Extended Synchronous Connection-Oriented (eSCO), and Asynchronous Connectionless (ACL). SCO may involve point-to-point communication between a peripheral device and a central device, and may be used to transport voice or audio data that uses a time bound, limited latency. SCO may use a set of reserved slots and never re-transmits its data. eSCO may be similar to SCO, except that it may support retransmitting the data after the reserved slots. ACL may involve point-to-multipoint communication between a central device and all peripheral devices in a piconet. Accordingly, ACL packets may be not addressed to a specific peripheral device. ACL may allow for packet retransmission, and may allow for gaps in transmission if there is no data to send.

According to embodiments, SCO transport may use High Quality Voice (HV) and Data Voice (DV) packets, eSCO transport may use EV, POLL and NULL packets, and ACL transport may use Data Medium Rate (DM) or Data High Rate (DH) packets. Table 1 below provides examples of packet designations for DH packets, which may be indicated or reported in the packet type of field of a packet header as discussed above.

TABLE 1

| Packet Designation | Modulation Format | Timeslots |
|---|---|---|
| 2-DH1 | 2 Mbps | One |
| 3-DH1 | 3 Mbps | One |
| 2-DH3 | 2 Mbps | Three |
| 3-DH3 | 2 Mbps | Three |
| 2-DH5 | 2 Mbps | Five |
| 3-DH5 | 3 Mbps | Five |

As can be seen in Table 1, the first number in the EDR packet designation may indicate the EDR modulation used (e.g., 2 Mb/s or 3 Mb/s), and the second number may indicate the number of timeslots that the packet occupies (e.g., one timeslot for 2-DH1, three timeslots for 2-DH3, and five timeslots for 3-DH5).

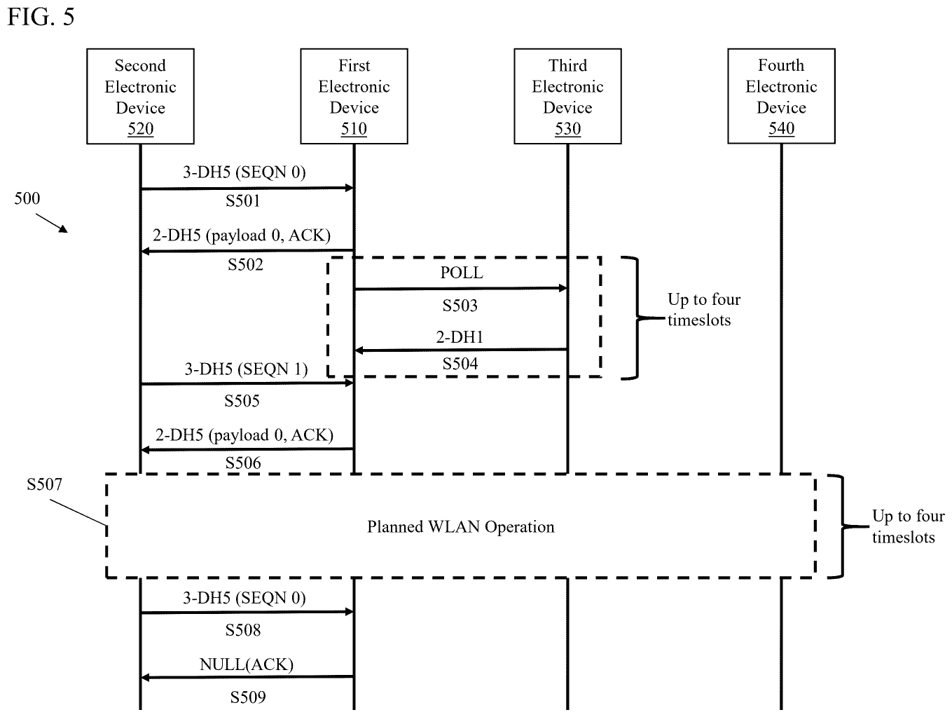

FIG. 5 shows an example process for managing wireless communication, according to an embodiment. As shown in FIG. 5, a first electronic device 510, a second electronic device 520, a third electronic device 530, and a fourth electronic device 540 may perform wireless communication using various wireless connections. According to embodiments, each of the first to fourth electronic devices 510 to 540 may correspond to one or more of the electronic device 100 and the electronic device 200 discussed above.

In embodiments, the first electronic device 510, the second electronic device 520, and the third electronic device 530 may be included in a scatternet. For example, the scatternet may include a first piconet in which the second electronic device 520 operates as a central device and the first electronic device 510 acts as a peripheral device, and a second piconet in which the first electronic device 510 operates as a central device and the third electronic device 530 operates as a peripheral device. For example, the third electronic device 530 may be a human interface device (HID) connected to the first electronic device 510. However, embodiments are not limited thereto, and in some embodiments the first electronic device 510 may be connected to the third electronic device 530 using a connection other than a Bluetooth connection, for example a different type of wireless connection. In embodiments, the fourth electronic device may communicate with one or more of the first to third electronic devices 510 to 530, or to another electronic device, using a WLAN such as a Wi-Fi network.

According to embodiments, a packet type field of a header of a Bluetooth BR/EDR packet may be used to nudge communication on the link to happen at particular times, or to enforce that no communication on that Bluetooth connection happens at particular times. The gap in the Bluetooth communication may then be used for other purposes, for example to perform other Bluetooth activities, or to perform other activities such as WLAN or cellular activities co-located in the same electronic device communicating using Bluetooth. These periods of no communication on the link may also be done to avoid known sources of interference, so that they do not affect the Bluetooth communication.

For example, according to embodiments, a device such as the first electronic device 510 may send a truncated packet which includes no payload or a short payload, and which also include a header which indicates that the packet is a large packet. For example, the first electronic device 510 may send small payloads of data that may fit into a one-timeslot packet, and may set the packet type field in the header to indicate that the packet is a three-timeslot packet or a five-timeslot packet. This may cause peer devices to cease communicating on the link until the three timeslots or the five timeslots have passed.

According to embodiments, the truncated packets may operate similarly to normal packets, and may comply with the relevant rules for a particular link. Therefore, the truncated packets may be used by any device without previous negotiation with any peer devices on a link. In addition, according to embodiments, a device may decide to use the truncated packets on a per-transmitted-packet basis.

For example, as shown in FIG. 5, at operation S501 the second electronic device 520 may send a first packet, which may be for example a 3-DH5 packet, to the second electronic device. After receiving this packet from the second electronic device 520, the first electronic device 510 may need to communicate with the third electronic device 530, in a way that might interfere with the Bluetooth connection between the first electronic device 510 and the second electronic device 520.

In order to provide a sufficient gap or opening, the first electronic device may transmit a truncated packet to the second electronic device 520 to prevent the second electronic device from transmitting using the Bluetooth connection during the opening. For example, at operation S502, the first electronic device may transmit a 2-DH5 packet which does not include any payload to the second electronic device 520. The header of the 2-DH5 packet indicates or reports that it occupies five timeslots (e.g., may indicate that a length of the payload is such that the 2-DH5 packet occupies five timeslots). Therefore, the second electronic device 520 may wait until the five timeslots have passed before transmitting a new packet. This may provide a gap or opening in which the first electronic device 510 may communicate with the third electronic device 530, while ensuring that this communication will not interfere with the Bluetooth connection between the second electronic device 520 and the first electronic device 510, and also ensuring that the first electronic device 510 will not miss any packets from the second electronic device 520. During the gap or opening, at operation S503, the first electronic device 510 may transmit a POLL packet to the third electronic device 530, and at operation S504, the third electronic device 530 may respond with a 2-DH1 packet. According to embodiments, operation S502 may occupy, for example, one timeslot, which means that the gap or opening may therefore be up to four timeslots (which may correspond to a difference between the payload length indicated or reported by the header, and the actual payload length). Accordingly, operations S503 and S504 may occupy up to four timeslots as illustrated in FIG. 5.

At operation S505, after the five timeslots have passed, the second electronic device 520 may transmit a second packet, which may be for example a 3-DH5 packet, to the first electronic device 510. After receiving this packet from the second electronic device 520, the first electronic device 510 may be aware of a planned WLAN operation which is to be performed by the fourth electronic device 540 in a way that might interfere with the Bluetooth connection between the first electronic device 510 and the second electronic device 520. In order to provide a sufficient gap or opening, the first electronic device may transmit another truncated packet to the second electronic device 520 to prevent the second electronic device from transmitting using the Bluetooth connection during the opening. For example, at operation S506, the first electronic device may transmit a 2-DH5 packet which does not include any payload to the second electronic device 520. The header of the 2-DH5 packet indicates or reports that it occupies five timeslots (e.g., may indicate that a length of the payload is such that the 2-DH5 packet occupies five timeslots). Therefore, the second electronic device 520 may wait until the five timeslots have passed before transmitting a new packet. This may provide a gap or opening in which the planned WLAN operation may be performed at operation S507 by the fourth electronic device 540, while ensuring that this operation will not interfere with the Bluetooth connection between the second electronic device 520 and the first electronic device 510, and also ensuring that the first electronic device 510 will not miss any packets from the second electronic device 520. According to embodiments, operation S506 may occupy, for example, one timeslot, which means that the gap or opening may therefore be up to four timeslots (which may correspond to a difference between the payload length indicated or reported by the header, and the actual payload length). Accordingly, operation S507 may occupy up to four timeslots as illustrated in FIG. 5.

At operation S508, after the five timeslots have passed, the second electronic device 520 may transmit a third packet, which may be for example a 3-DH5 packet, to the first electronic device 510. At operation S509, the first electronic device 510 may transmit a NULL packet acknowledging this packet.

Although examples are discussed above in which the truncated packet is transmitted by a peripheral device (e.g., the first electronic device 510), embodiments are not limited thereto. For example, in some embodiments the truncated packet may be transmitted by a central device such as the second electronic device 520. In addition, although examples are discussed above in which the truncated packet includes no payload, embodiments are not limited thereto. For example, in some embodiments the truncated packet may include a payload that is small but non-zero, for example a payload that would fit into a one-timeslot packet or a three-timeslot packet.

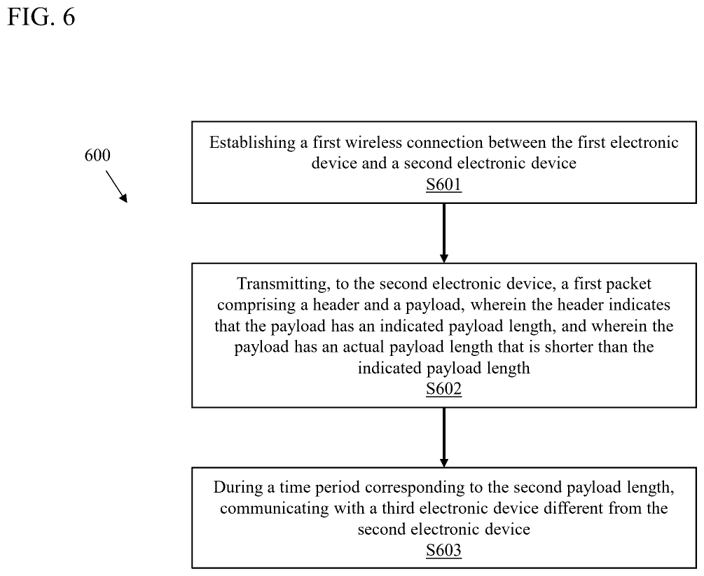

FIG. 6 is a flowchart of a process 600 for performing wireless communication, according to embodiments. In embodiments, one or more of the operations of the process 600 may be performed by any of the electronic devices discussed above with reference to FIGS. 1-5.

As shown in FIG. 6, at operation S601 the process 600 may include establishing a first wireless connection between the first electronic device and a second electronic device. In embodiments, the first electronic device may correspond to the first electronic device 510, the second electronic device may correspond to the second electronic device 520, and the first wireless connection may correspond to a Bluetooth BR/EDR connection.

As further shown in FIG. 6, at operation S602, the process 600 may include transmitting, to the second electronic device, a first packet including a header and a payload. In embodiments, the header may indicate or report that the payload has a particular payload length, which may be referred to as a reported payload length. However, the payload may actually have a different payload length, which may be referred to as an actual payload length, that is shorter than the reported payload length. In embodiments, the first packet may correspond to the truncated packet discussed above.

As further shown in FIG. 6, at operation S603, the process 600 may include, during a time period corresponding to the reported payload length, communicating with a third electronic device different from the second electronic device. In embodiments, the third electronic device may correspond to at least one of the third electronic device 530 and the fourth electronic device 540 discussed above.

In embodiments, the header may indicate that the second electronic device is not permitted to transmit using the first wireless connection during the time period.

In embodiments, the process 600 may further include, after the time period ends, receiving a second packet from the second electronic device using the first wireless connection.

In embodiments, the first wireless connection may correspond to at least one from among a Bluetooth BR protocol and a Bluetooth EDR protocol.

In embodiments, the communicating may be performed using a second wireless connection different from the first wireless connection.

In embodiments, the second wireless connection may correspond to at least one from among another Bluetooth connection and a Wi-Fi connection.

In embodiments, the actual payload length may correspond to a one-timeslot packet, and the reported payload length may to at least one of a three-timeslot packet and a five-timeslot packet.

In embodiments, the first electronic device and the second electronic device may be included in a scatternet, the first electronic device may include a peripheral device of the scatternet, and the second electronic device may include a central device of the scatternet.

In embodiments, the third electronic device may include a peripheral device of the scatternet.

Although FIGS. 5-6 show example blocks of the processes 500 and 600, in some implementations, the processes 500 and 600 may include additional blocks, fewer blocks, different blocks, or differently arranged blocks than those depicted in FIGS. 5-6. Additionally, or alternatively, two or more of the blocks of the processes 500 and 600 may be arranged or combined in any order, or performed in parallel.

Accordingly, embodiments may use Bluetooth BR/EDR features to force gaps in communication on the BR/EDR Bluetooth link, either to avoid known interfering signals, or to allow the time to be used for other purposes without affecting the performance on the Bluetooth BR/EDR link in a negative manner. Therefore, embodiments may provide improved coexistence with other wireless activities, not limited to one technology. In addition, embodiments may reduce or minimize the risk of missing communication attempts from peer devices engaged in a particular Bluetooth connection, by ensuring that the peer devices will not transmit at times when other activities are being serviced.

The electronic device according to various embodiments disclosed in the present disclosure may be one of various types of electronic devices. The electronic devices may include, for example, a portable communication device (e.g., a smartphone), a computer device, a portable multimedia device, a portable medical device, a camera, a wearable device, or a home appliance. According to embodiments of the disclosure, the electronic devices are not limited to those described above.

It should be appreciated that various embodiments of the disclosure and the terms used therein are not intended to limit the technological features set forth herein to particular embodiments and include various changes, equivalents, or relocations for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

One or more embodiments as set forth herein may be implemented as software (e.g., the program 1640) including one or more instructions that are stored in a storage medium (e.g., internal memory 1636 or external memory 1638) that is readable by a machine (e.g., the electronic device 1601). For example, a processor (e.g., the processor 1620) of the machine (e.g., the electronic device 1601) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method of performing wireless communication, the method being executed by at least one processor of a first electronic device, the method comprising:
establishing a first wireless connection between the first electronic device and a second electronic device;
transmitting, to the second electronic device, a first packet comprising a header and a payload, wherein the header indicates that the payload has a reported payload length, and wherein the payload has an actual payload length that is shorter than the reported payload length;
during a time period corresponding to the reported payload length, communicating with a third electronic device different from the second electronic device.

2. The method of claim 1, wherein the header indicates that the second electronic device is not permitted to transmit using the first wireless connection during the time period.

3. The method of claim 1, further comprising:
after the time period ends, receiving a second packet from the second electronic device using the first wireless connection.

4. The method of claim 1, wherein the first wireless connection corresponds to at least one from among a Bluetooth basic rate protocol and a Bluetooth enhanced data rate protocol.

5. The method of claim 4, wherein the communicating is performed using a second wireless connection different from the first wireless connection.

6. The method of claim 5, wherein the second wireless connection corresponds to at least one from among the Bluetooth basic rate protocol, the Bluetooth enhanced data rate protocol, and a Wi-Fi protocol.

7. The method of claim 4, wherein the actual payload length corresponds to a one-timeslot packet,
wherein the reported payload length corresponds to at least one of a three-timeslot packet and a five-timeslot packet.

8. The method of claim 7, wherein the first electronic device and the second electronic device are included in a scatternet,
wherein the first electronic device comprises a peripheral device of the scatternet, and
wherein the second electronic device comprises a central device of the scatternet.

9. The method of claim 8, wherein the third electronic device comprises a peripheral device of the scatternet.

10. A first electronic device for performing wireless communication, the first electronic device comprising:
a communication interface configured to perform wireless communication with a second electronic device and a third electronic device;
at least one processor; and
a memory configured to store instructions which, when executed by the at least one processor, causes the first electronic device to:
establish a first wireless connection between the first electronic device and a second electronic device using the communication interface,
transmit, to the second electronic device, a first packet comprising a header and a payload, wherein the header indicates that the payload has a reported payload length, and wherein the payload has an actual payload length that is shorter than the reported payload length, and
during a time period corresponding to the reported payload length, communicate with a third electronic device different from the second electronic device.

11. The first electronic device of claim 10, wherein the header indicates that the second electronic device is not permitted to transmit using the first wireless connection during the time period.

12. The first electronic device of claim 10, wherein the instructions further cause the at least one processor to, after the time period ends, receive a second packet from the second electronic device using the first wireless connection.

13. The first electronic device of claim 10, wherein the first wireless connection corresponds to at least one from among a Bluetooth basic rate protocol and a Bluetooth enhanced data rate protocol.

14. The first electronic device of claim 13, wherein the communicating is performed using a second wireless connection different from the first wireless connection.

15. The first electronic device of claim 14, wherein the second wireless connection corresponds to at least one from among the Bluetooth basic rate protocol, the Bluetooth enhanced data rate protocol, and a Wi-Fi protocol.

16. The first electronic device of claim 13, wherein the actual payload length corresponds to a one-timeslot packet,
wherein the reported payload length corresponds to at least one of a three-timeslot packet and a five-timeslot packet.

17. The first electronic device of claim 16, wherein the first electronic device and the second electronic device are included in a scatternet,
wherein the first electronic device comprises a peripheral device of the scatternet, and
wherein the second electronic device comprises a central device of the scatternet.

18. The first electronic device of claim 17, wherein the third electronic device comprises a peripheral device of the scatternet.

19. A non-transitory computer-readable medium including instructions which, when executed by at least one processor of a first electronic device for performing wireless communication, causes the first electronic device to:
establish a first wireless connection between the first electronic device and a second electronic device;
transmit, to the second electronic device, a first packet comprising a header and a payload, wherein the header indicates that the payload has a reported payload length, and wherein the payload has an actual payload length that is shorter than the reported payload length; and
during a time period corresponding to the reported payload length, communicate with a third electronic device different from the second electronic device.

20. The non-transitory computer-readable medium of claim 19, wherein the header indicates that the second electronic device is not permitted to transmit using the first wireless connection during the time period.
